(19) United States
(12) Patent Application Publication
(10) Pub. No.: US 2016/0239461 A1
(43) Pub. Date: Aug. 18, 2016

(54) RECONFIGURABLE GRAPH PROCESSOR

(71) Applicant: SYNAPTIC ENGINES, LLC, Naperville, IL (US)

(72) Inventor: Gautam Kavipurapu, Germantown, TN (US)

(21) Appl. No.: 15/137,175

(22) Filed: Apr. 25, 2016

Related U.S. Application Data
(63) Continuation of application No. 13/783,209, filed on Mar. 1, 2013, now abandoned.

(51) Int. Cl. G06F 15/80; G06F 9/38

(52) U.S. Cl. CPC G06F 15/80; G06F 9/3887; G06F 9/3889; G06F 9/3802; G06F 9/3016

(57) ABSTRACT

A graph processor has a planar matrix array of system resources. Resources in a same matrix or different planar matrices are interconnected through port blocks or global switched memories. Each port block includes a broadcast switch element and a receive switch element. The graph processor executes atomic execution paths that are generated from data flow graphs or computer programs by a scheduler. The scheduler linearizes resources and memories. The scheduler further maintains a linearized score board for tracking states of the resources.

### CROSS REFERENCE TO RELATED APPLICATIONS

This application is a continuation application of co-pending U.S. patent application Ser. No. 13/783,209, entitled “RECONFIGURABLE GRAPH PROCESSOR,” filed Mar. 1, 2013, assigned to SYNAPTIC ENGINES, LLC of Naperville, Ill., and which is hereby incorporated by reference in its entirety to provide continuity of disclosure.

### FIELD OF THE DISCLOSURE

The present invention relates to reconfigurable multi-processor and multi-core processor systems, and more particularly relates to a new type of processor referred to herein as a reconfigurable graph processor.

### DESCRIPTION OF BACKGROUND

A computer system generally comprises one or more processor and other components, such as an arithmetic-logical unit (“ALU”), graphics processing unit (“GPU”), networking interfaces, video controller, etc. A system with multiple processors is generally referred to as a multi-processor system. Current processors often have multiple independent or related central processing cores (“cores”). Such processors are termed herein as multi-core processors. Conventional microprocessors are implemented using control and instruction/data pipeline paths. For multi-core processors, or superscalar processors, multiple instances of the pipeline are instantiated. Most of the processor instances have their own local data and instruction caches while they share a global data or instruction cache. A conventional processor with a single core or ALU is shown in FIG. 1, where native code is loaded into an instruction pipeline while the associated data (also referred to herein as operands) is loaded in a data pipeline.

Microprocessor based systems can run a computer operating system (“OS”), such as UNIX, LINUX and Windows. Some operating systems are designed for embedded or real time systems. An operating system is a collection of software programs that manages computer system resources, such as Input/Output (“I/O”), memory, storage, etc. For instance, operating systems schedule tasks and arbitrate contention for various system resources. Moreover, operating systems provide common services (such as memory allocation and file system access) for computer programs.

Processor cores read and execute computer program instructions. The instructions are low level and processor dependent instructions (i.e., “native code,” “byte code” or “op code”). The low level instructions can be programmed using low level computer programming languages, such as assembly languages. Oftentimes, the low level instructions are translated from high level computer program instructions which are written in high level computer programming languages, such as C, C++, Java, Pascal, Fortran, C#, etc. Computer programs that are written in high level languages include two types of instructions, namely simple and compound (or complex) instructions. As used herein, the simple and compound instructions refer to computer program instructions that are written or programmed in high level computer programming languages, such as C or C++.

Simple instructions and compound instructions translate to atomic instructions or atomic operations. A simple instruction, such as a basic addition operation (A+B), has only one atomic operation, namely an addition. Any atomic instruction refers to an instruction operating on one or two operands with a single operator, such as addition and subtraction operators as shown in an operator column 402 of FIG. 4. Referring now to FIG. 4, two operand columns 404 and 406 indicate the number of required operands for the corresponding operators in the operator column 402. A result column 408 indicates whether a data result is generated from the corresponding operators in the operator column 402. An overflow column 410 indicates whether an overflow condition can occur for the corresponding operators in the operator column 402. A complex instruction comprises more than one atomic operation. For example, the complex instruction (A+B)*C includes an addition operation and a multiplication operation.

The translation from high level computer languages to low level computer instructions (such as op codes or byte code) is performed by a computer program (or program in short) compiler or translator. The compiler generates lower level commands from and controls the breakdown of the set of instructions that are written in high level computer programming languages and forms a task. A processor then loads the generated byte codes into memory and subsequently into cache along with the data they operate on before it executes the byte codes.

Basic components of a compiler are illustrated by reference to FIG. 2. A language dependent front end component 202 parses a computer programming language (such as C++), in which a computer program is written, into a common form or format. An optimizer component 204 performs certain local and high level code optimization for generating faster-running machine code using various techniques. For example, loop unrolling is a technique for increasing pipeline utilization. A different optimizer component 206 performs global optimization and certain local optimization. For example, the optimizer 206 handles and optimizes memory allocation. A lower level component 208 is a code generator that generates byte code.

The compiler components can be partitioned into hardware and software layers, depending on a specific system design. Usually, in systems requiring static code generation, all compiler components are implemented in software and the native or byte code to be executed on the target processor is generated statically. In systems requiring dynamic code generation, some of the compiler components may be implemented in hardware. Implementing compiler components in hardware reduces system flexibility and the re-programmability of the system using a high level programming language.

The components 206 and 208 are oftentimes referred to as a scheduler which schedules, at compile time, the tasks called for in the code for execution by a target processor. Scheduling also includes implementing memory management functions such as controlling the use of global registers and the utilization of different levels in memory hierarchy. Usually, tasks are scheduled through the ordering of instructions in a sequence and the insertion of memory references. Moreover, conventional scheduling is static such that the order of instructions is set at compile time and cannot be changed later.

Another important function of the schedulers is binding. Binding is the process of optimizing code execution by associating different properties to a sequence of instructions. In resource binding, a sequence of operations is mapped to the resources required for their execution. If several instructions are mapped to the same hardware resource for execution, the scheduler, under the resource binding protocol, distributes the execution of the set of instructions by resources based on a given set of constraints to optimize system performance. Hardware or system resources include, without limitation, adders, multipliers, dividers, custom instructions units, hard macros to execute signal or image processing functions, ALUs, registers, etc. Generally most scheduling related concerns or problems are modeled as Integer Linear Programming problems, where the schedule of a required sequence of instructions is decided based on a set of simultaneous linear equations.

An intermediate output of the compiler, which can be fed into a scheduler, a data flow graph (“DFG”) and/or control flow graph (“CFG”). Example data flow graphs illustrating the operations executed in a processor are shown by reference to FIG. 3. Two data flow graphs 302 and 304 illustrate operations for performing the function or instruction: (A+B)*C, where A, B and C are variables, such as integer variables. Two sequencing graphs 306 and 308, corresponding to the data flow graphs 302 and 304 respectively, demonstrate how the function can be executed by the target processor. The difference in the two data flow graphs 302 and 304 illustrates instruction level parallelism (“ILP”) and pipeline level parallelism (“PLP”). ILP is a measure of how many of operations in a computer program that can be performed simultaneously.

In the paradigm of the PLP, long sequences of operations or tasks are parallel. Additionally, PLP supports overlapping sequential processes during which no parallel tasks are permitted. PLP is similar to thread level parallelism or task level parallelism. ILP takes advantage of sequences of instructions that require different functional units (such as the load unit, ALU, FP multiplier, etc.). Different architectures implement ILP in different ways while they all execute independent instructions simultaneously to keep the functional units busy. Another type of parallelism is data level parallelism (“DLP”), under which a same operation is performed on multiple data simultaneously. A classic example of DLP is performing an operation on an image where processing an individual pixel is independent from processing other pixels in the image. Other types of operations that allow the exploitation of DLP are matrix, array, and vector processing.

For example, to perform the following operations,

e=a+b Operation 1:

f=c*d Operation 2:

g=e+f Operation 3:

a processor can perform Operation 1 and Operation 2 concurrently since they do not depend on each other for data. There are generally two approaches to implement instruction level parallelism. One approach is at the hardware level while the other is at the software level. Hardware level works upon dynamic parallelism whereas the software level works on static parallelism. For example, Pentium processors exploit instruction and data parallelism to perform out of order execution and completion of instructions (i.e., dynamic execution) while Itanium processors use explicit ILP, making the compilers for exploiting the resources on the processor more complex.

In a standard pipelined processor, to minimize the number of registers used for executing the function, the data flow graph 302 is used. To speed up execution, the clock frequency of the processor needs to be increased. Increased clock frequency reduces the value of each of the time steps in the sequencing graph 306. Oftentimes, to maintain flexibility, a processor needs to be able to execute the instruction of FIG. 3 using either the DFG 302 or the DFG 304.

Accordingly, there is a need for a new type of processor that can execute a dynamically or statically generated execution path or graph. The new type of processor can dynamically configure and allocate hardware resources for executing data flow or control flow graphs. The new processor should also be able to exploit different types of parallelism, namely data, instruction, pipeline and thread implicitly present in the sequential code. Another objective of the new type of processor is to accommodate future parallel programming paradigms that may be developed. It must be noted that till recently all computer programming was done sequentially and compilers and instructions accordingly generated sequential code.

For future evolutions, the new processor should have the ability to mimic the inherent parallel processing of biological brains where a neuron or nerve cell is an element that can compute, store information and communicate through its dendrites. For systems that encompass coupling of biological and electronics systems, a processor needs to provide a natural fit into such biological systems where the paths, traversed through the processor, should have the ability to dynamically form and reform such as synapses of the nerve cells in the brain.

### OBJECTS OF THE DISCLOSED SYSTEM, METHOD, AND APPARATUS

Accordingly, it is an object of this invention to provide a graph processor with a planar matrix array of interconnected atomic execution units.

Another object of this invention is to provide a graph processor with a planar matrix array of atomic execution units interconnected via port blocks.

Another object of this invention is to provide a graph processor utilizing port blocks with broadcast switch elements and receive switch elements.

Another object of this invention is to provide a graph processor with a planar matrix array of atomic execution units interconnected via bank witched memories.

Another object of this invention is to provide a graph processor for dynamically generating atomic execution graphs or paths.

Another object of this invention is to provide a scheduler for mapping computer programs or tasks to atomic execution paths for a graph processor.

Another object of this invention is to provide a graph processor for executing dynamically generated execution graphs or paths.

Another object of this invention is to provide a scheduler with a score board and scheduled operations for a graph processor.

Another object of this invention is to provide a scheduler with a linearized memory block for storing a score board and scheduled operations.

Another object of this invention is to provide a soft scheduler for a graph processor.

Another object of this invention is to provide a hardwired scheduler for a graph processor.

Other advantages of the disclosed invention will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

Accordingly it is an advantage of the present teachings to provide a graph processor for utilizing a two-dimensional or three-dimensional planar matrix array of hardware or system resources to execute atomic execution paths or graphs. A planar matrix array includes one or more matrices. Each planar matrix comprises a plurality of resources. The resources in a same planar matrix (or plane or bank) are interconnected using port blocks. Each port block includes a broadcast switch element and a receive switch element. The resources in different planes are also interconnected via port blocks or global switched memories. The resources in the planar matrix array are reconfigurable to run different atomic execution paths or graphs.

Another advantage of the present teachings is to provide a scheduler that linearizes a flow graph (such a DFG or CFG) into a score board. The flow graph is translated from a set of computer program instructions. Each node of the flow graph corresponds to an entry in the score board. The scheduler maps each node in the score board to an atomic operation. The atomic operations form an atomic execution path or graph which is executed by a graph processor. Moreover, the states of resources of the planar matrix array are stored in a linearized resource array. Each entry of the linearized resource array includes coordinates, state, type and other information of the corresponding resource.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a functional block diagram depicting a prior art processor pipeline;

FIG. 2 is a simplified block diagram depicting a computer program complier in accordance with the teachings of this disclosure;

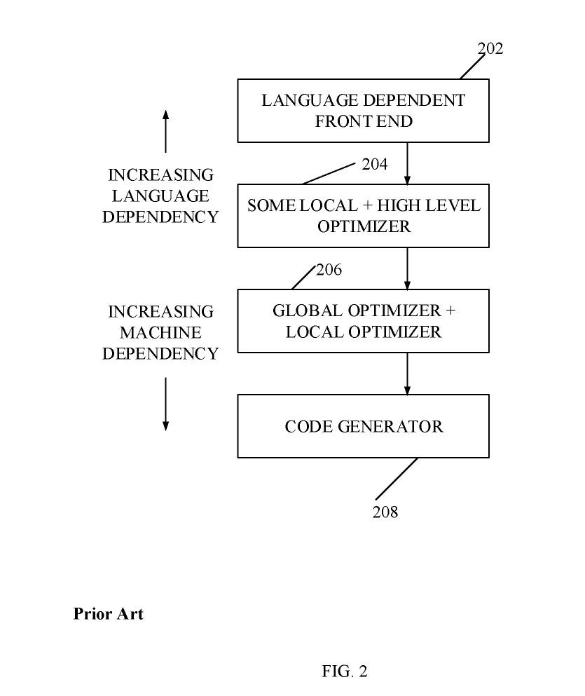

FIG. 3 is a data flow and sequencing diagram generated from parsing a computer program instruction in accordance with the teachings of this disclosure;

FIG. 4 is a sample set of atomic operations performed by a graph processor in accordance with the teachings of this disclosure;

FIG. 5 is a block diagram depicting the architecture of a graph processor in accordance with the teachings of this disclosure;

FIG. 6 is a block diagram depicting the architecture of a fully connected graph processor in accordance with the teachings of this disclosure;

FIG. 7 is a block diagram depicting an atomic execution row element and data port block of a fully connected graph processor in accordance with the teachings of this disclosure;

FIG. 8 is a block diagram depicting the architecture of a bank connected graph processor in accordance with the teachings of this disclosure;

FIG. 9 is a block diagram depicting an atomic execution row element and data port block of a bank connected graph processor in accordance with the teachings of this disclosure;

FIG. 10 is a block diagram depicting an execution path mapped from a data flow graph on a graph processor in accordance with the teachings of this disclosure;

FIG. 11 is a block diagram depicting a scheduler for a graph processor in accordance with the teachings of this disclosure;

FIG. 12 is a block diagram depicting a system-on-chip with a graph processor as a co-processor with a software scheduler in accordance with the teachings of this disclosure;

FIG. 13 is a block diagram depicting a system with a hardware scheduler and a graph processor as a co-processor in accordance with the teachings of this disclosure;

FIG. 14 is a block diagram depicting the architecture of an integrated switching device based graph processor in accordance with the teachings of this disclosure;

FIG. 15 is a block diagram depicting the execution of an atomic execution unit with one operand on a graph processor in accordance with the teachings of this disclosure;

FIG. 16 is a block diagram depicting the execution of an atomic execution unit with two operands on a graph processor in accordance with the teachings of this disclosure;

FIG. 17 is a block diagram depicting a graph processor in accordance with the teachings of this disclosure;

FIG. 18 is a block diagram depicting an execution path mapped from a snippet of computer program code on a graph processor in accordance with the teachings of this disclosure;

FIG. 19 is a block diagram illustrating a three dimensional view of a fully connected graph processor in accordance with the teachings of this disclosure;

FIG. 20 is a block diagram illustrating a three dimensional view of an integrated switching device based graph processor in accordance with the teachings of this disclosure;

FIG. 21 is a block diagram depicting a linearized memory map for a graph processor in accordance with the teachings of this disclosure;

FIG. 22 is a block diagram depicting the structure of a non-self-routing instruction on a graph processor in accordance with the teachings of this disclosure;

FIG. 23 is a block diagram depicting the structure of a self-routing instruction on a graph processor in accordance with the teachings of this disclosure; and

FIG. 24 is a block diagram of a System On Chip (“SOC”) or a graph processor with system resources interconnected using an Integrated Switching Device (“ISD”) in accordance with the teachings of this disclosure.

### DETAILED DESCRIPTION

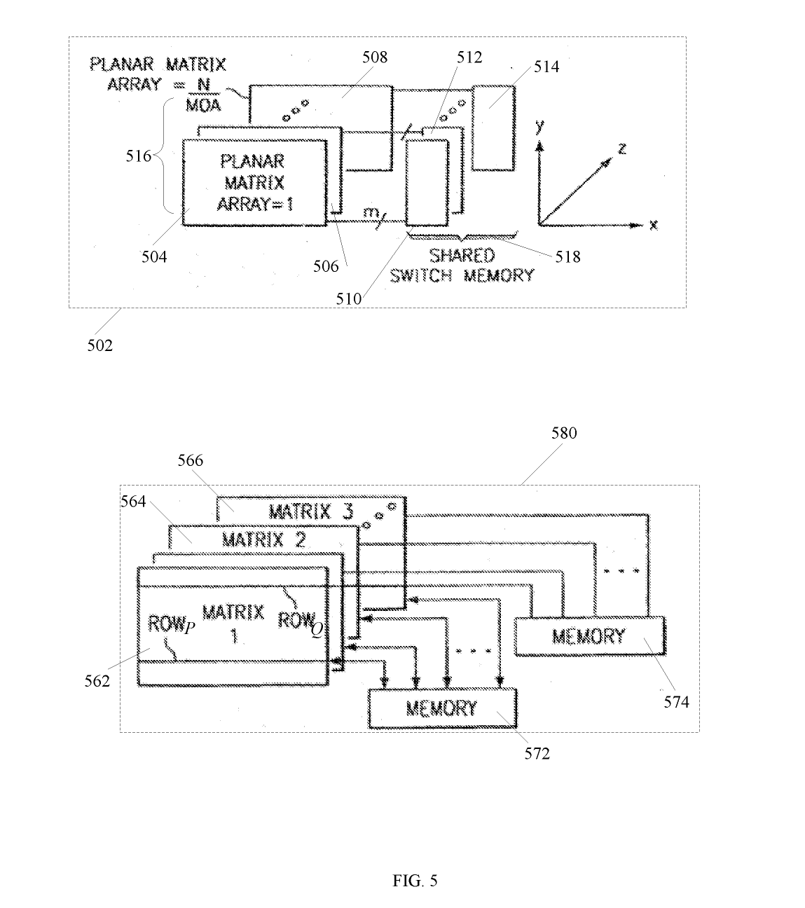

Turning to the Figures and to FIG. 5 in particular, the architecture of a graph processor 502 is shown. The processor 502 includes a planar matrix array 516. The planar matrix array 516 includes a set of planar matrices 504,506,508. The number of planar matrices is not limited to three as illustrated in FIG. 5. Where the number of the planar matrices is one, the graph processor is 502 is said to be planar. Where the number of planar matrices is more than one, the processor 502 is said to be multi-planar, three dimensional (“3-D”), 3-D, 3-D stacking or stacked die. In one implementation, the planar matrices are constructed using multi-chip modules. Both multi-planar graph processors and non-planar graph processors can execute non-planar data flow graphs and/or control flow graphs (such as instructions with a loop or jump statement). Planar data flow graphs and control flow graphs are sequential. The non-planar and multi-planar processors provide the flexibility to traverse the matrix of multiple atomic operational units using multiple paths with variable delays and costs.

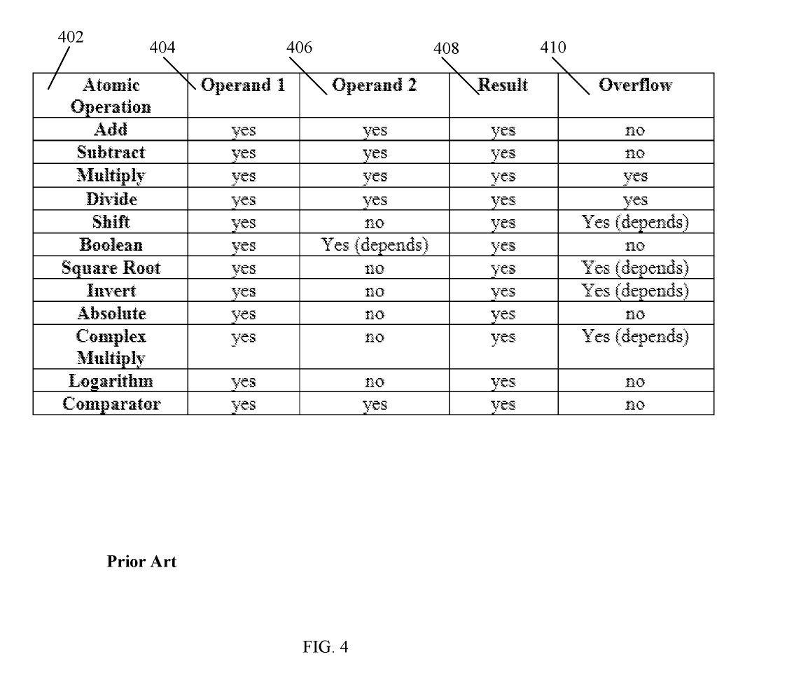

Each planar matrix (also referred to herein as plane or bank) includes m rows and n columns of resources. As used herein, m and n stand for positive integers. A resource is used for executing a particular atomic instruction, such as those shown in FIG. 4, required for the processor 502 to perform a task. Accordingly, the resources are also referred to as atomic execution units. The atomic execution units include, without limitation, adders, subtraction, multipliers, dividers, ALUs, registers, shift, move, square root, boolean operators (such as AND, OR, NOT, NOR, NAND, XOR and other commonly used logic operators) and others. The atomic execution units can be configured to operate on 16, 32, 64 bit or other data sizes and types such as IEEE fixed or floating point. An implementation of a graph processor may include a subset of the above atomic executions units or all of them in varying numbers in the processor.

In the illustrative cubic configuration of FIG. 5, a cube of N (N is a positive integer) atomic execution units form N/(m*n) planes of atomic execution units. It should be noted that other types of configurations of the graph processor can be implemented without altering the nature of the present teachings.

In the processor 502, a physical interconnection exists between any two resources. In one embodiment, the interconnection is implemented using an array of shared switched memories 518, which includes switched memories 510,512,514. As used herein, switched memories are also referred to as switch memories, bank switched memories and global switched memories. In one implementation, the number of switched memories is the same as the number of the planar matrices 504,506,508. Each resource on a plane, such as the bank 504, is connected directly or indirectly through other resources to a switch memory, such as the switch memory 510. Additionally, resources on the same plane are interconnected. In a further implementation, recourses on different planes are interconnected using shared switch memories like memories 572 and 574 in a graph processor 580. For example, the interconnection of resources in a same row P (meaning a positive integer) on each plane (such as planes 562,564,566) of a planar matrix array are implemented using the memory 572.

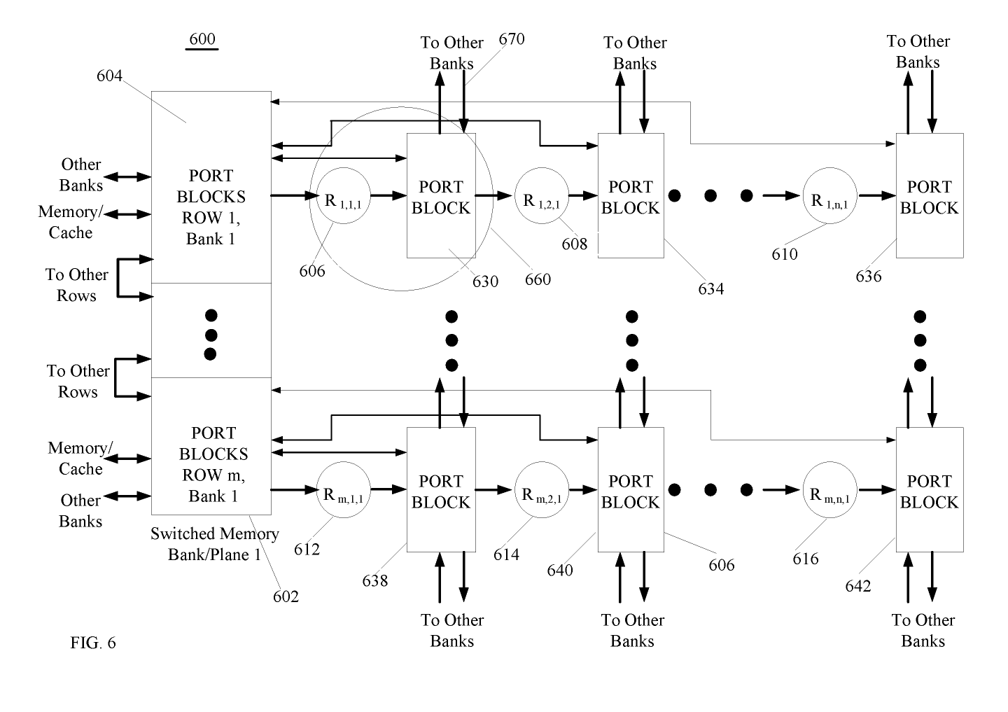

The interconnection of atomic execution units are further illustrated by reference to FIG. 6, where a fully connected graph processor 600 is shown. In the fully connected graph processor 600, resources (such as a resource 608) on the same and different planes are interconnected. The interconnection topology is same as that of the processor 580. In the processor 600, on each plane, there are m rows and n columns of resources, such as resources 606,608,610,612,614,616. For example, the resource 606, indicated as R_{1,1,1}, is in the first row and first column of the first plane of the graph processor 600. As an additional example, the resource 614, indicated as R_{m,2,1}, is in the m-th row and 2nd column of the first plane of the graph processor 600.

The resources of the processor 600 are interconnected using port blocks (“PB”). For example, the resources 606,608,610 are interconnected via port blocks 630,634 and other port blocks (not shown). Resources on different rows are also interconnected. For example, the resources 606 and 642 are interconnected through different paths. One such path includes the port blocks 630,638,606. An alternative path includes the port blocks 630,634,606. Moreover, resources on different planes are interconnected. For example, Resources R_{1,1,1} and R_{1,1,2} can be interconnected, as indicated at 670, through the port block 630 and the port block that is on the second plane and is located immediately between resources R_{1,1,2} and R_{1,1,2}.

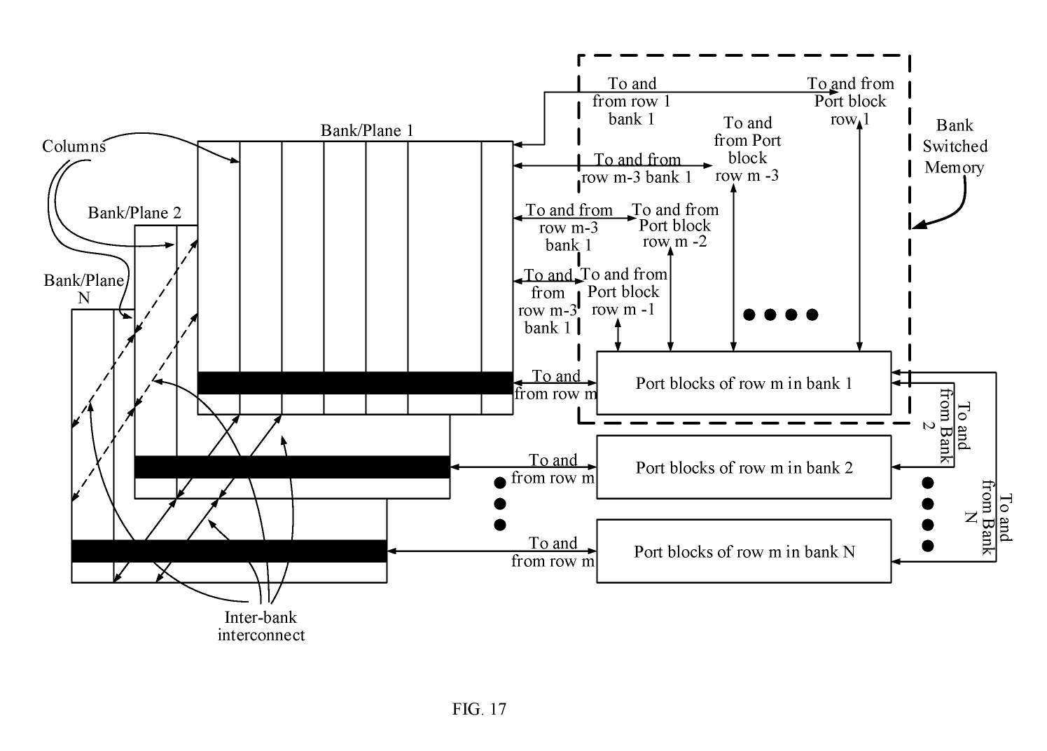

The interconnection between resources on different planes is also supported using switched memories, such as switched memories 602,604. The switched memories include multiple registers. Each of the registers is a port block. These port blocks are interconnected. Additionally, the switched memories interconnect with memory cache that holds data to be operated on by the processor 600. The switched memories are further illustrated by reference to FIG. 17. The port blocks interconnecting the resources/atomic units and the switch memories also serve as registers and register files respectively. Accordingly, the port blocks and the switch memories function as an extension of the lowest level cache for the graph processor.

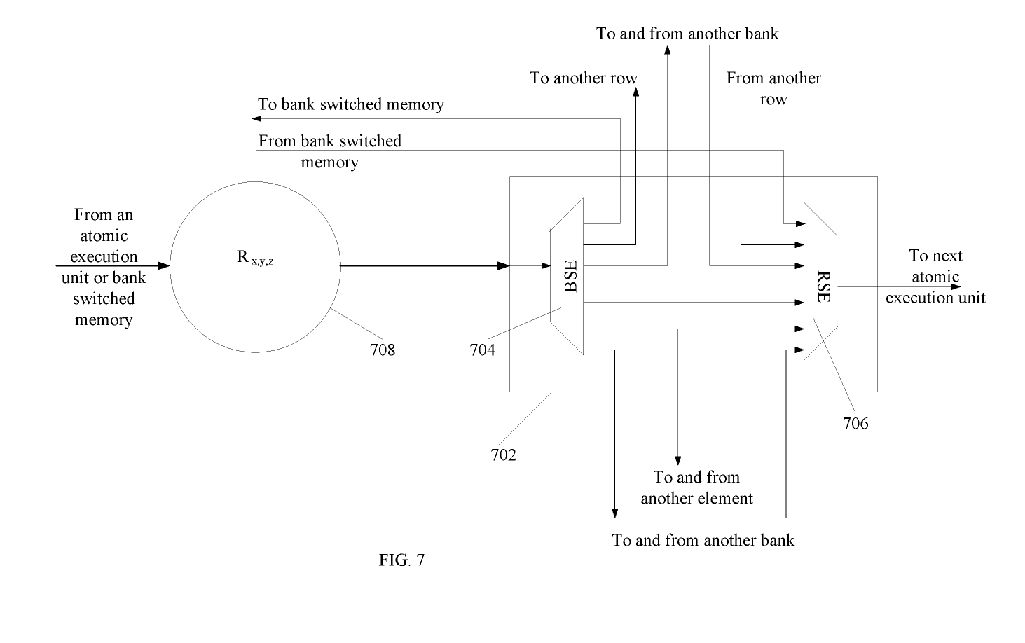

The interconnecting port blocks are implemented using Broadcast Switch Elements (“BSEs”) and Receive Switch Elements (“RSEs”) as shown in FIG. 7. BSEs and RSEs are more fully set forth in U.S. Pat. No. 6,504,786, which is incorporated herein by reference. In accordance with the teaching of the U.S. Pat. No. 6,504,786, port blocks can be implemented using Static Random-access Memory (“SRAM”) or Dynamic Random-access Memory (“DRAM”) memories/cells. Moreover, port blocks can be implemented using other types of memory cells, such as Magnetic Ran (“MRAM”) cells. A resource 708 is connected to a port block 702, which includes a BSE 704 and a RSE 706. In some implementations, the size of the BSE port 704 can be 16 bits, 32 bits or 64 bits data paths corresponding to the size of the atomic execution unit 708. The size of the RSE port 706 is twice of that of the BSE port 704.

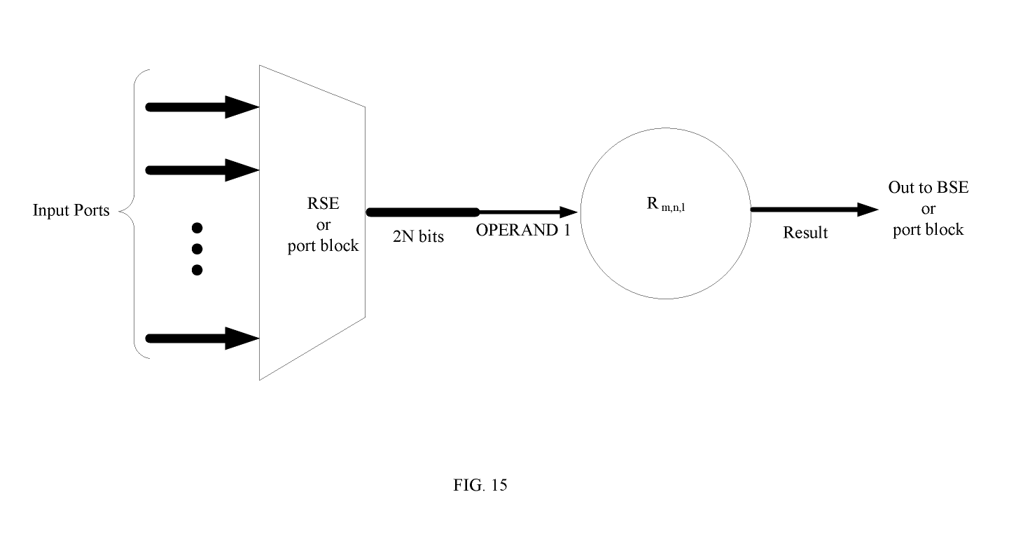

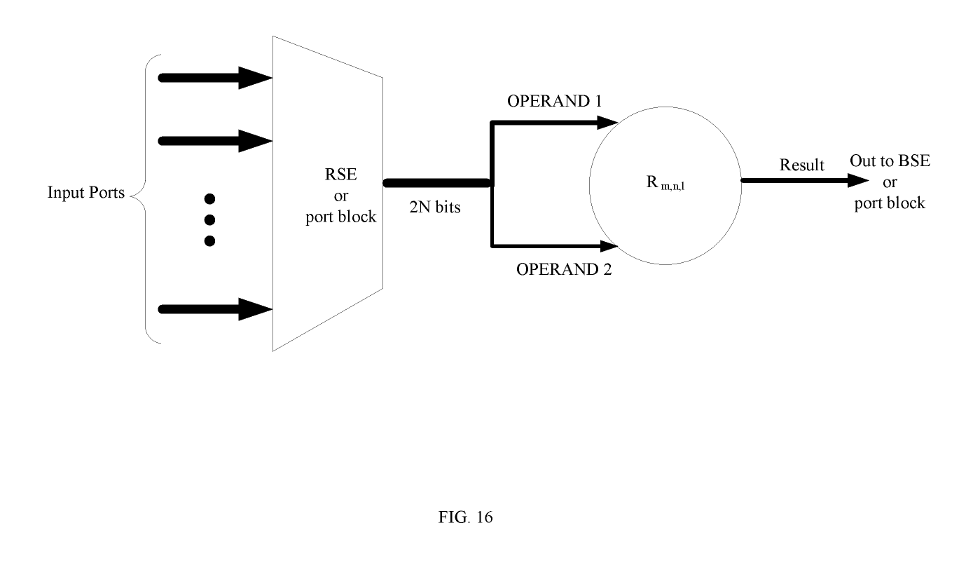

The output from the BSE 704 can be sent to a bank switched memory (such as the switched memory 602), a resource in the same plane as the resource 708 or a resource in a different plane. Similarly, the input for the RSE 706 can be received from a bank switched memory, a resource in a same plane as the port block 708 or a resource in a different plane. The BSEs and RSEs, used by port blocks, provide bidirectional communication between resources of different rows, columns or banks. The insertion of memory elements (BSEs and RSEs) between resources allows for introducing variable delays to make dynamic scheduling possible. The introduction of variable delays enables dynamic and static mapping/binding flow graphs (such as the graphs 302 and 304) to the processor 600. The operation of atomic execution units and communications between port blocks and atomic execution units are further illustrated by reference to FIGS. 15 and 16.

FIGS. 15 and 16 illustrate the execution of an automatic execution unit with one or two operands respectively. Each operand and result is N bits wide. Input ports to each port block or RSE are N bits wide. The port block or RSE selects either one or two of the input ports as the input to the atomic unit R_{m,n,1}. In one implementation that is shown in FIG. 16, the port block's output is 2N bits with the N Least Significant Bits (“LSB”) containing operand 1 and the N Most Significant Bits (“MSB”) containing operand 2. In a different implementation that is shown in FIG. 15, there is only one operand to be fed into an atomic operation unit. In such a case, the MSB of the 2N bits wide path can be all zeros. Alternatively, an N bits path can be connected from the output of the RSE to the atomic execution unit. Under this implementation, one input is selected from multiple inputs to the port block or RSE. For example an atomic unit that only executes an inversion operation can have an N bits input and N bits output. However an atomic unit implementing Boolean type operations can have a 2N bits wide input to allow for flexibility. For example, a Boolean NOT operation requires only one operand while a Boolean AND operation requires with two operands.

The illustrative implementation can be modified to include self-routing instructions or automatic execution instructions. Self-routing instructions can be constructed in a packet form wherein a header contains the path (or co-ordinates) of nodes that they pass through in the planes of the processor 600 or 800. The payload of the packet then contains the data and instructions or just data with the header containing instructions. The packet automatically routes through the matrix until it runs out of co-ordinates and the final result is stored in a global register. The result can be re-used if necessary in another path based computation or sent out to the user as a result of executing the task or program.

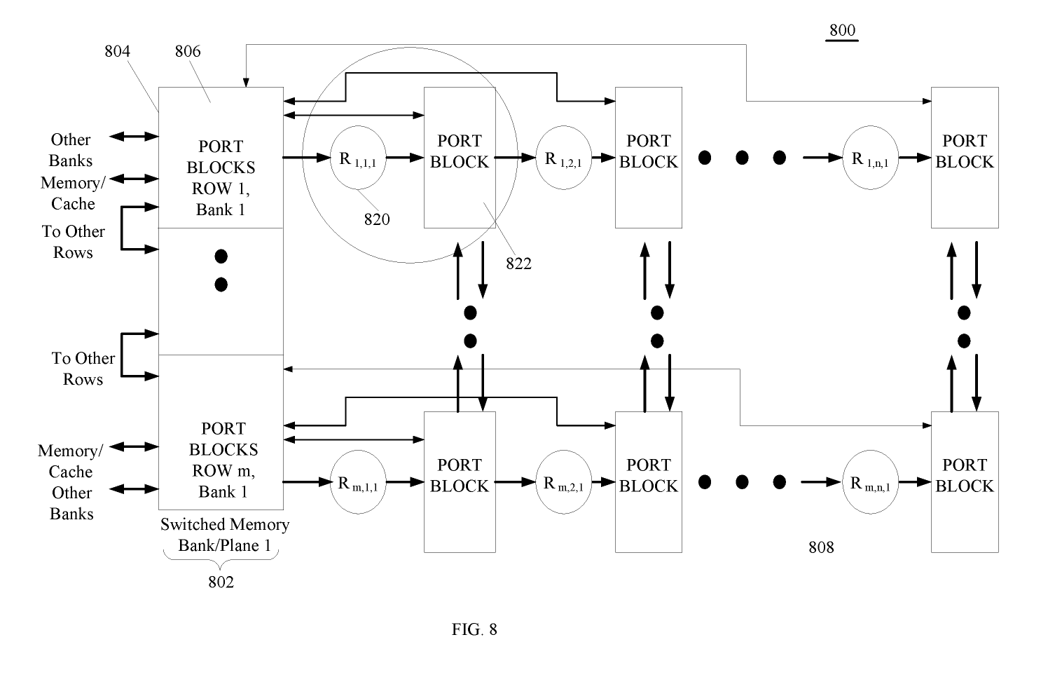

FIG. 8 illustrates a bank connected graph processor 800. In the processor 800, the interconnection between resources on two different planes has to go through a global switched memory 802 which includes a number of bank switched memories, such as a switched memory 804 for plane 1. In other words, the port blocks of different planes of the processor 800 are not directly interconnected. Each switched memory includes multiple registers or port blocks 806. Within the global switched memory 802, bank switched memories are interconnected. The interconnection between resources on a same plane is the same as that of the graph processor 600. However, resources on different planes interconnect via the global switched memory 802. For example, an interconnection path between resources R_{1,1,1} and R_{1,1,2} includes the port blocks, at row 1 and column 1 of planes 1 and 2, of the global switched memory 802.

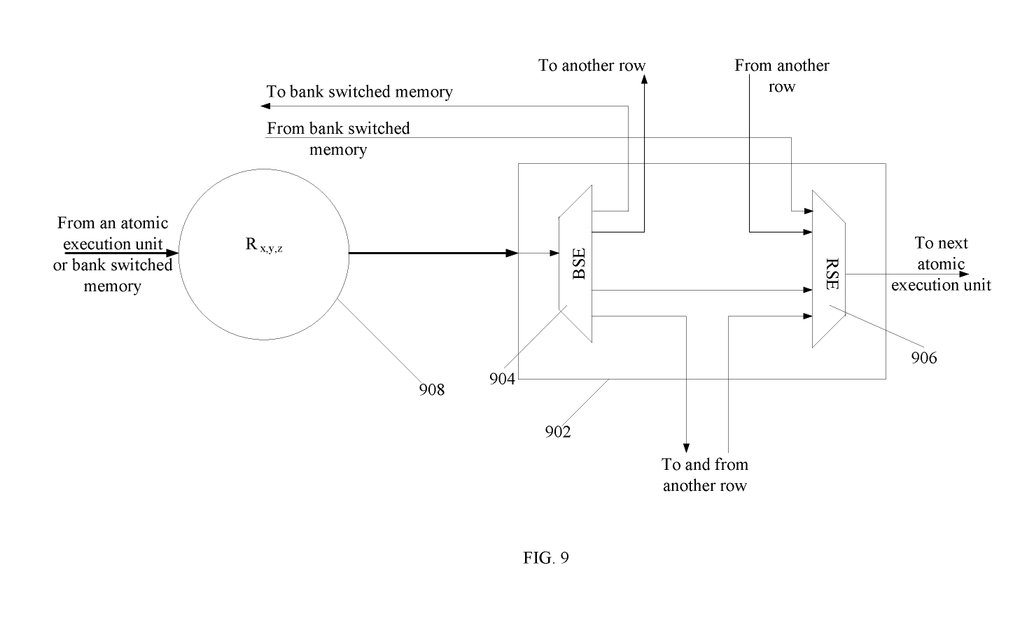

Referring to FIG. 9, a resource 908 and a port block 902 of the processor 800 are shown. The resource 908 connects to the port block 902, which includes a BSE 904 and a RSE 906. The output from the BSE 904 is sent to a bank switched memory (such as the switched memory 802) or a resource in the same plane as the resource 908. However, the output from the BSE 904 cannot be directly sent to a resource in a plane different from that of the resource 908. The input for the RSE 906 can be received from a bank switched memory or a resource in a same plane as the port block 902. However, the input for the RSE 906 cannot be received from a resource in a plane different from that of the resource 908.

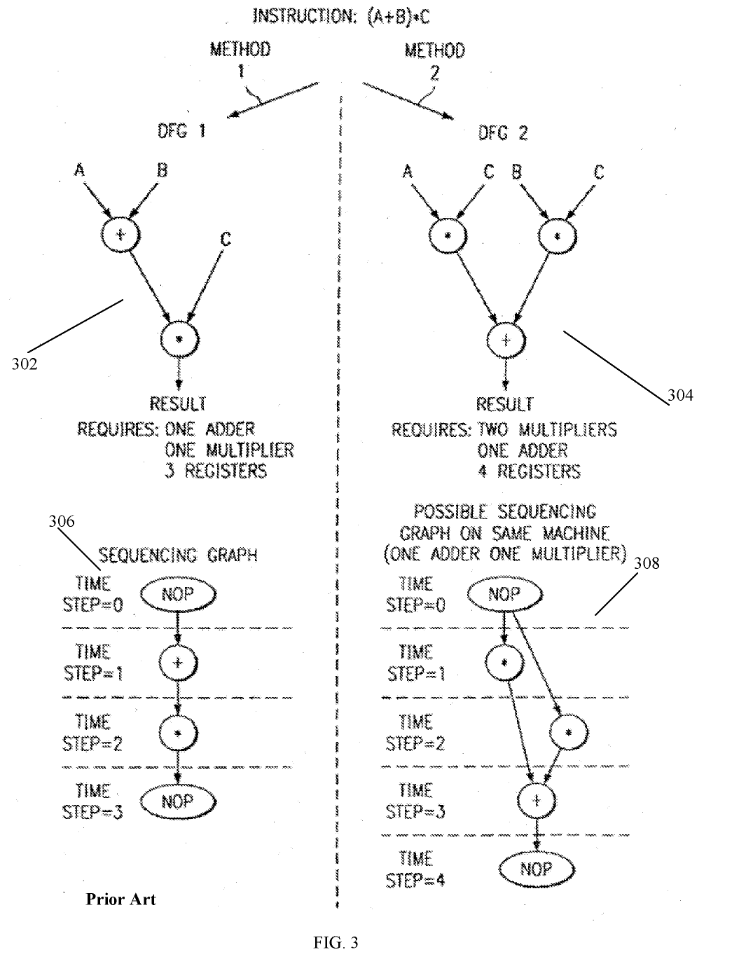

A task can be decomposed into a set of atomic instructions or operations, such as the DFG of FIG. 3. For execution of the set of atomic instructions, the nodes of the DFG are mapped to resources in a planar matrix array of a graph processor, such as that of the processor 600 or processor 800. In one implementation, all atomic execution units of a fully connected processor costs equal amount of time; and the traversal time between any two consecutive resources is constant or close to be constant. In such a case, the cost function for executing a task is the function of how many resources that are mapped to from a corresponding DFG of the task. Accordingly, minimizing the cost to execute the task is equivalent to calculating the least costly execution path or graph to traverse through the 3-dimensional matrix of resources in a graph processor.

There is a different cost to go from an atomic execution resource to the next atomic execution unit in the same row compared to going from an atomic execution unit in the same row to the next row or the next bank. The cost then becomes a function of the memory nodes (i.e., port blocks, RSEs or BSEs). The port blocks comprise BSEs and RSEs and function as input operand and output result registers. They also serve as switch (such as mux and de-mux) elements that route the data. Since these elements can be built from block RAMs in Field Programmable Gate Arrays (“FPGAs”), SRAM memories in Application Specific Integrated Circuits (“ASICs”), embedded DRAM or other types of memory (Volatile or Non-Volatile), they have the capability to store the operand or the output result of a computation performed by an atomic execution unit.

The capability to store data enables these elements to hold the data for a predetermined amount of time, which can be determined by a scheduler. Accordingly, variable delays can be introduced in an execution path corresponding to a sequence of instructions. In other words, variable delays can be introduced in traversing from one atomic execution unit to another atomic execution unit in a same row, different rows or different banks. This variable delay is a part of the traversal cost function and can be changed based on the scheduling directives at run time dynamically. A cost baseline can be set based on the configuration parameters of the processor (or engine) being constructed, such as the number of elements and the type and delay of each element. For example a multiplier might take 5 machine clocks to complete and produce a result. In this case, the total delay is then the delay of the computation (5 clocks) plus the programmable delay in the port block (i.e., the variable delay that is introduced in the port block by the scheduler). Since the port block delay is programmable, the cost can be computed as the cost to traverse a same row, different rows in a same bank and/or between rows in different banks using the execution time of each atomic execution unit and the minimum delay for each RSE and/or BSE in the computation path. The total cost to execute a particular execution path or graph is thus the sum of all costs to traverse all the atomic execution units or elements of the graph plus variable delays.

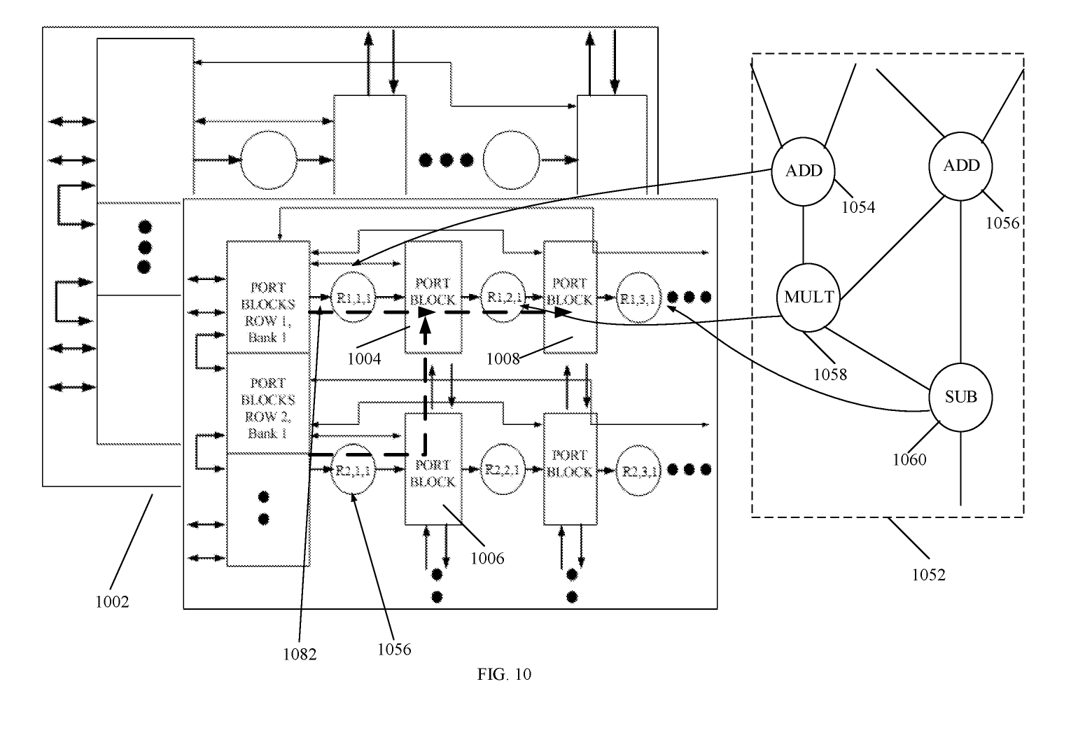

An example execution path is illustrated by reference to FIG. 10. A partial DFG 1052 includes four nodes or atomic instructions 1054,1056,1058,1060 that are respectively mapped to resources R_{1,1,1}, R_{2,1,1}, R_{1,2,1} and R_{1,3,1} of a graph processor 1002. Accordingly, an execution path or graph 1082 (indicated by dashed lines) for the processor 1002 is formed to include R_{1,1,1}, R_{2,1,1}, R_{1,2,1}, R_{1,3,1} and port blocks 1004,1006,1008. Depending on the availability and types of the atomic execution units, the DFG 1052 may be mapped to, for example, resources R_{1,1,1}, R_{2,1,1}, R_{1,2,1} and R_{2,3,1} of the graph processor 1002. As an additional example, the DFG 1052 may be mapped to, for example, resources R_{1,1,1}, R_{3,1,1}, R_{1,2,1} and R_{2,3,2} of the graph processor 1002.

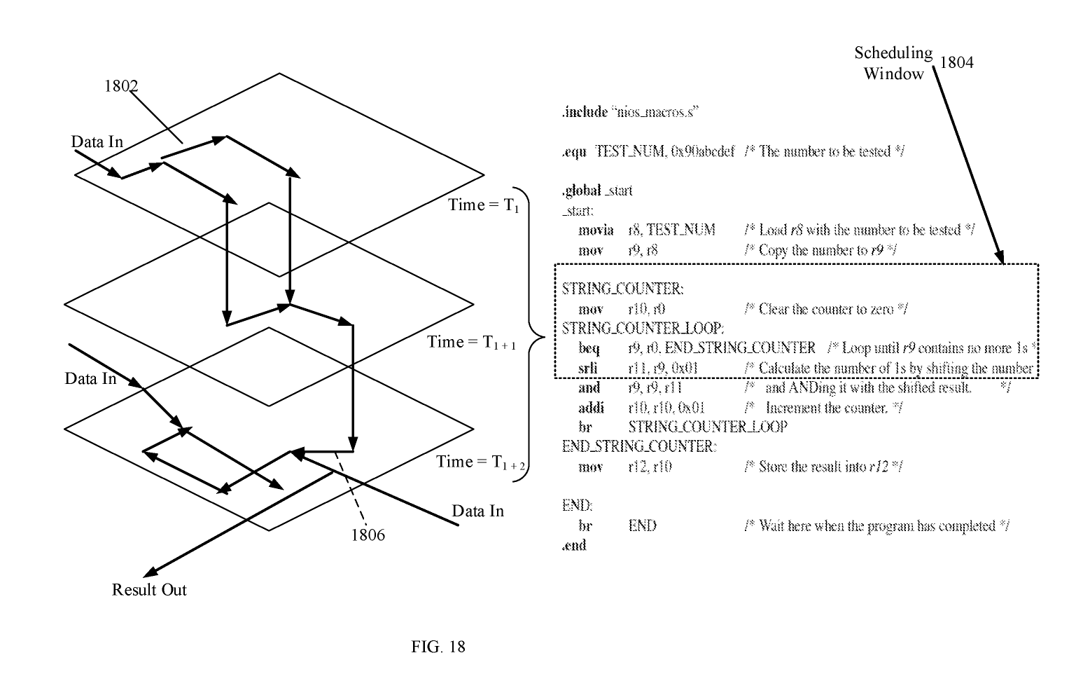

As an additional example, an atomic execution path 1802 of FIG. 18, mapped from a snippet of computer program code, is shown within a 3-D cuboid interconnection structure (such as the planar matrix array 516). The snippet of computer program code is within a scheduling window 1804. The execution path 1802 includes a plurality of segments (such as segment 1806), each of which represents a link between two resources and a port block in a planar matrix array. The execution path can be executed at different times, such as time steps T₁, T₁₊₁, and T₁₊₂, each of which is on a clock cycle of the underlying graph processor.

An execution path or graph in a graph processor and corresponding input data constitute a solution to a specific physical problem. Accordingly, low cost and high performance devices and system can be built to replace microcontrollers. Such devices and systems do not require compilers. In one implementation, such devices are programmed onto FPGAs for repeated use. Alternatively, such devices can be built as an SOC (meaning a system on a chip).

For certain problems, the execution paths or graphs can be hardwired for graph processors that are used as stand-alone processors. For example, to implement a fast Fourier transformation (“FFT”) or other algorithms with specific input data, the corresponding execution paths can be hardwired for a set of data. In such cases, the input data or operands can be placed into registers. Subsequently, each set of operands are operated on by a same set of instructions. These types of algorithms and problems involve predetermined data flow mapping without utilizing a compiler on the target graph processor. In such cases, it can be said that the data or operands flow through a specific set of operators and the interdependencies remain the same every time the execution path or graph is executed. Moreover, the execution path or graph is said to be virtually hardwired to the target processor. In other words, a fixed schedule or fixed atomic execution path. In one implementation, the fixed execution path includes a fixed set of atomic execution units. In a different implementation, the fixed execution path includes a fixed set of types of atomic execution units. In other words, the fixed execution path includes a fixed set of atomic operations. Each such operation may be performed by different atomic execution units of the same type.

The scheduler can also be optimized and hardwired. Furthermore, it can be a fixed schedule that is optimized to execute one algorithm or flow graph. This can be used to create either custom engines or processors that do not require compilers and can be wired directly to the inputs which after passing through the graph processor result in the desired output. These types of processors have many applications. The path traversed matches the flow graph and in effect implements the algorithm or function. These types of graph processors can be used as standalone processors or as co-processors to traditional micro-processors or micro-controllers based on the application.

For a particular algorithm or application, if the algorithm or the corresponding execution graph is virtually hardwired, a compiler is no longer required. Execution of the algorithm or execution graph can then be viewed as a transfer function that is implemented in the graph processor and converts a set of inputs into one or more outputs. Such graph processors can be utilized in controls (of, such as, automotive, aeronautical and other electromechanical devices), communications, cryptography, encryption, encoding and decoding, image processing, etc. Accordingly, a simple method for connecting the inputs to the outputs are written into a programmable scheduler; and the graph processor is then configured to execute that particular transfer function or algorithm.

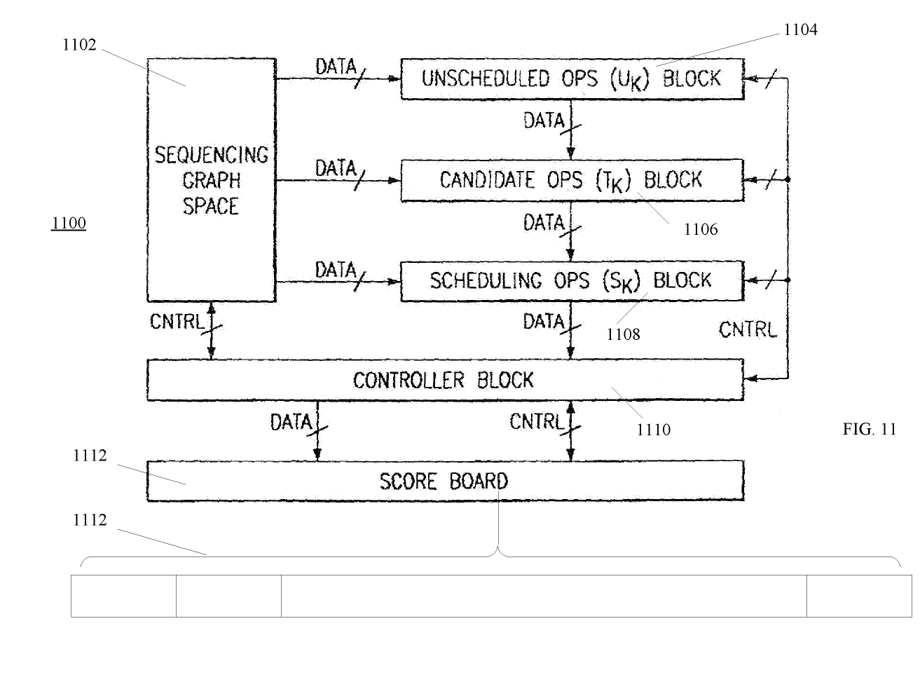

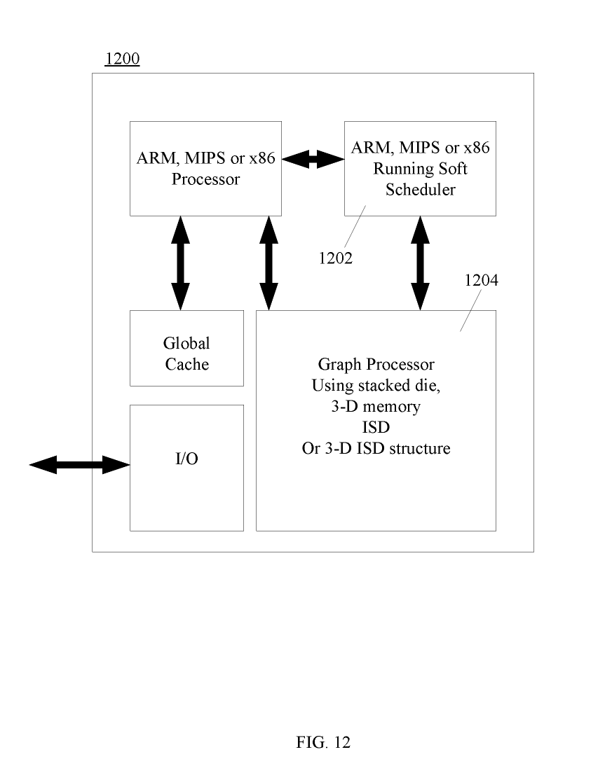

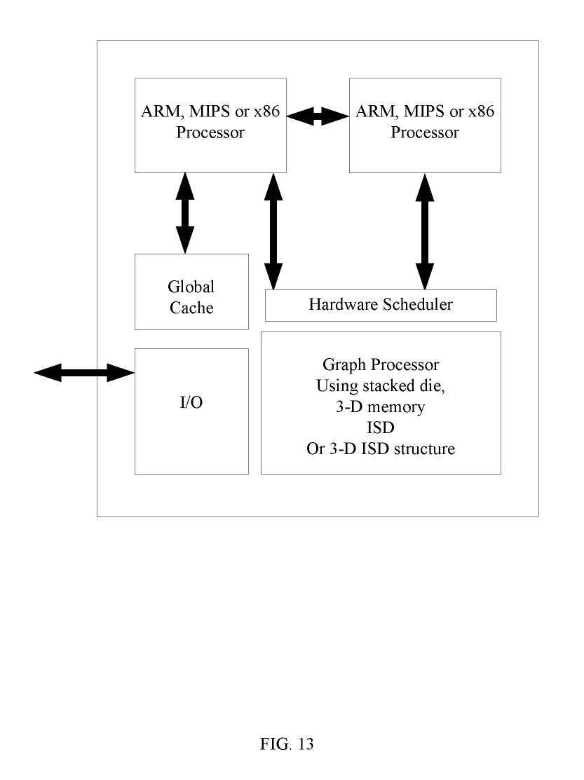

A block diagram of a scheduler is illustrated by reference to FIG. 11. The elements of a scheduler 1100 especially the memories can be implemented as software data structures or hardwired memories in the processor. The memory elements can be formed with Flash type of memory elements, such as MRAM, FRAM, SRAM or DRAM cells. The soft scheduler and hardwired scheduler implementations are further illustrated in FIGS. 12 and 13 respectively. In FIG. 12, a control processor 1202, such as an x86, MIPS or ARM 32 bit or 64 bit processor, is used to run a soft scheduler. In such a case, a graph processor (such as the graph processors 600 and 800) 1204 is used as a co-processor; and the scheduler for the graph processor is implemented in the embedded control processor.

Turning back to FIG. 11, the scheduler 1100 enables dynamic scheduling and binding at run time not available in most processors. Dynamic scheduling and binding at run time support reprogrammability and simultaneous implementation of multiple functions in a graph processor. However, with a custom compiler, static scheduling can also be generated. The scheduler 1100 uses memories in the processor and data structures to construct various elements, such as a sequencing graph space 1102. The sequencing graph space 1102 hosts or provides storage for data flow graphs representing parsed version of target code for the processor. Where byte code is generated by a compiler, the compiled byte code resides in the sequencing graph space 1102. Corresponding sequencing data flow graphs are generated using a scheduling algorithm.

Unscheduled operations, such as primitive operations or atomic instructions for the target processor resides in an unscheduled operation block 1104. Each operation is a node in a flow graph. Based on a window size, a specific number of candidate operations are selected for scheduling and put into a candidate operations block 1106. The window size is a multiple of the maximum clock frequency of the graph processor at which the graph processor operates. Usually, an embedded control processor, such as the processor 1202, operates at a much higher frequency. In one implementation, the clock frequency of the control processor is a multiple of the clock frequency of the graph processor. In one embodiment, the maximum clock frequency for the graph processor is set as the inverse of the slowest atomic execution or operation.

The scheduler 1100 further includes a scheduling operations block 1108 which hosts scheduled operations, and a controller block 1110. For synchronization purposes, scheduled instructions or operations are fed into the target processor cycle by cycle as the schedule is dynamically generated for a certain window. In such cases, both ILP and PLP can be utilized.

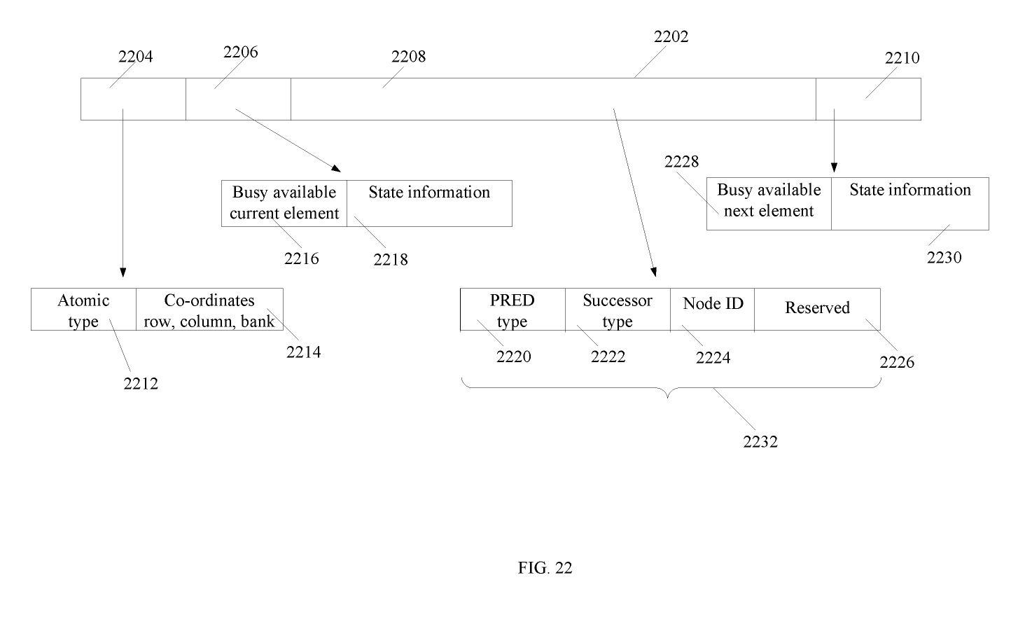

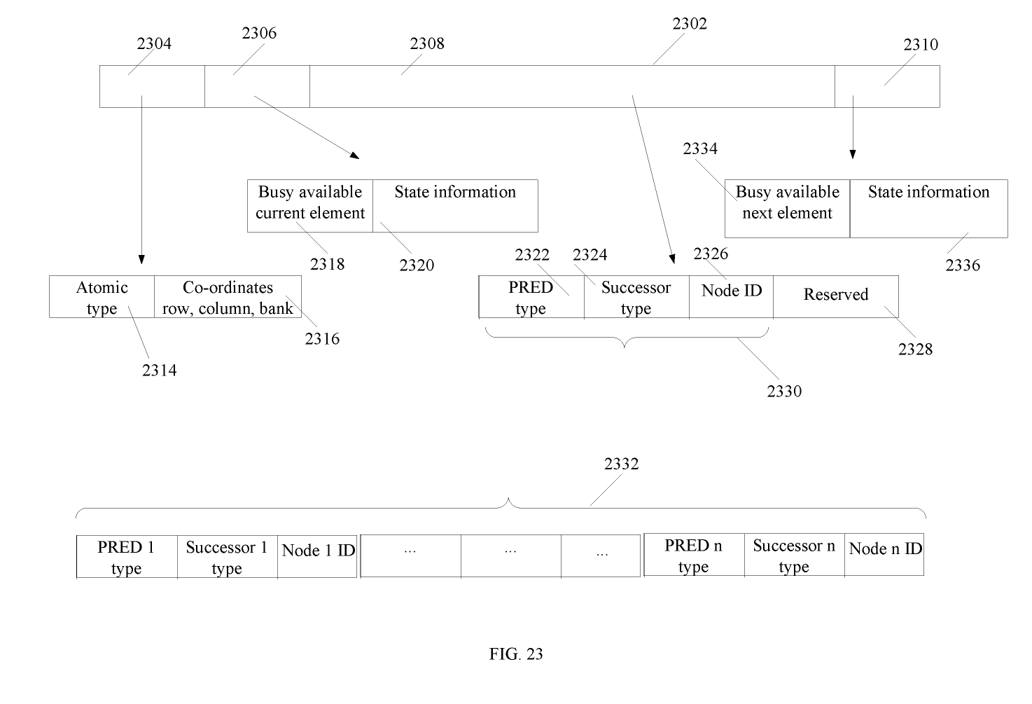

Additionally, the scheduler 1100 maintains a score board structure 1112 that can be implemented as data structures in software or a physical memory structure. The score board structure 1112 is further illustrated by reference to FIGS. 22 and 23. Referring now to FIGS. 22 and 23, the structures of a non-self-routing instruction and a self-routing instruction for a graph processor are indicated at 2202 and 2302 respectively. Both self-routing instructions and non-self-routing instructions reflect part or all of a flow graph. In a self-routing instruction for a graph processor, path traversal information is coded into the instruction. In one implementation, such coding is performed by a customized compiler. Alternatively, the path traversal information is explicitly specified by setting the routing of one or more operands through the lattices of a planar matrix array by explicitly setting the BSE and RSE outputs and routes.

The structure 2202 includes a first header field 2204 which includes an atomic type field 2212 and a coordinate field 2214. The atomic type field 2212 indicates the atomic operation type, such as multiplier type or adder type, of the currently executing atomic operation that corresponds to a node in a flow graph, such a DFG or CFG. The coordinate field 2214 contains the coordinates of the atomic execution unit within the planar matrix array of the underlying graph processor.

The structure 2202 also includes a second header field 2206 which includes a busy available current element field 2216 and a state information field 2218. The busy available current element field 2216 indicates whether the structure 2202 also includes the state information field 2218. The state information field 2218 indicates the element state such as idle, power up or powered down (which can be achieved through clock gating, i.e., supplying clock to the particular unit), executing, done executing, reading for the next instruction or error.

The structure 2202 also includes a payload field 2208 which includes one node field 2232. The node field 2232 includes a predecessor (“PRED”) type field 2220, a successor type field 2222, a node ID field 2224 and a reserved field 2226. The node ID field 2224 identifies or represents a node within a flow graph, such as a DFG or a CFG. The PRED type field 2220 indicates the type of the preceding node of the node, identified by the node ID field 2224, in the flow graph. Similarly, the successor type 2222 indicates the type of the succeeding node of the node, identified by the node ID field 2224, in the flow graph. When the graph processor executes the node identified by the node ID field 2224, this node is mapped to an atomic execution unit. The coordinates of the mapped atomic execution unit are stored in the coordinate field 2214. Moreover, the type of the mapped atomic execution unit is stored in the atomic type field 2212.

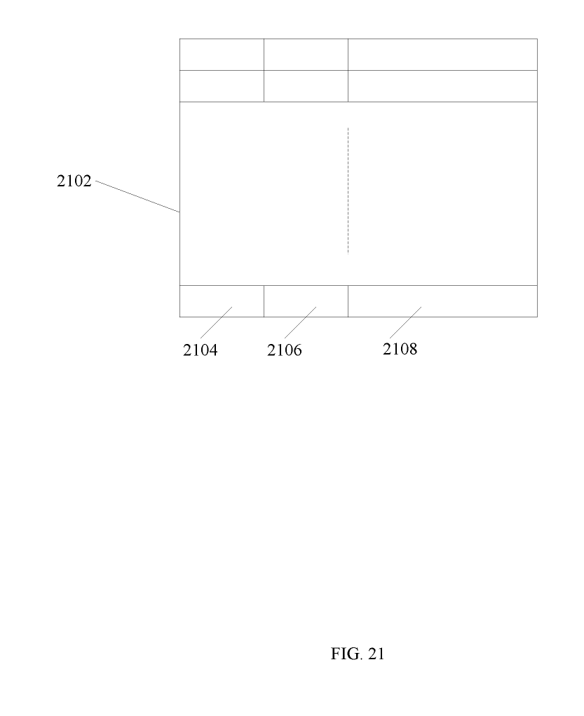

To map the node to the atomic execution unit, the graph processor searches an available resource by examining a linearized matrix array structure of the graph process. The selected or mapped to atomic execution unit must be available and have the same type as the operation type of the node. An illustrative linearized matrix array structure 2102 is shown by reference to FIG. 21. The structure 2102 can be implemented as a block of memory or registers. The structure 2102 includes one entry for each resource of the underlying graph processor. In other words, a cuboid interconnection structure (such as the planar matrix array 516) is linearized into a block of memory. Accordingly, indexing and sorting on resources are performed on the linear data structure.

Each entry in the structure 2102 includes a type field 2104, a state field 2106 and a coordinate field 2108. The type field 2104 specifies the type (such as adder, multiplier, Boolean operators, shifter, move, divider, etc.) of the corresponding resource in the planar matrix array of the graph processor. The coordinate field 2108 stores the coordinates of the corresponding resource. The state field 2104 tracks, at any time, the status or state of the corresponding resource of the graph processor. In one implementation, the states of a resource are indicated by two bits. The two bits can indicate any one of the four states below:

(1) Free/Available

(2) Busy/Scheduled

(3) OFF/Power Down

(4) Error

A simple encoding scheme can be used to represent the states. For example, 00 indicates Free or Available; 01 indicates Busy or Scheduled; 10 indicates Off or Power Down; and 11 indicates an Error condition.

Turning back to FIG. 22, the reserved field 2226 is reserved for other or future use. For example, the reserved field 2226 can used to specify a delay at the atomic execution unit. The structure 2202 also includes a busy available next element field 2228 and a state information field 2230. The busy available next element field 2228 indicates whether the structure 2202 also includes the state information field 2230 for the next element or node to be executed by the graph processor.

Referring to the structure 2302 of a self-routing instruction. The structure 2302 includes a first header field 2304 which includes an atomic type field 2314 and a coordinate field 2316. The structure 2302 also includes a second header field 2306 which includes a busy available current element field 2318 and a state information field 2320. The busy available current element field 2318 indicates whether the structure 2302 also includes the state information field 2320.

The structure 2302 further includes a payload field 2308 which includes one or more node fields 2330 and a reserved field 2328. The node field 2330 includes a predecessor type field 2322, a successor type field 2324, and a node ID field 2326. Where the payload field 2308 includes more than one node field, such mode fields are indicated at 2332. When the graph processor executes each of the multiple nodes, the currently executed node is mapped to an atomic execution unit. The coordinates of the mapped atomic execution unit within the planar matrix array of the graph processor are stored in the field 2316. Similarly, the type of the mapped atomic type is stored in the field 2314. In a different implementation, the nodes of the underlying flow graph are mapped to atomic execution units. The types and coordinates of all mapped atomic execution units are stored in the structure 2302.

The reserved field 2328 is reserved for other or future use. For example, the reserved field 2328 can used to specify delays at each hop or atomic execution unit. In a different implementation, each node field 2330 includes a reserved field 2328. The structure 2302 further includes a next element field 2310, which includes a busy available field 2334 for the next element, and a state information field 2336.

The advantage of deconstructing the concept of a single core or ALU into multiple fine grained units connected together is that programmable execution paths or graphs can be constructed to support a plurality of (such as hundreds) simultaneous pipelines. Accordingly, for operations like loop unrolling, multiple instances of the loop can be executed all at once in multiple places in the planar matrix. In one implementation, the loop is executed in one portion of the planar matrix while other instructions that do not have an instruction level or data dependency can be executed in another portion of the planar matrix using other atomic execution units and by traversing other execution paths. Instead of relying on performing complex operations (such as register re-naming), a graph processor can be configured to be data flow aware and use a single or only up to two or three pipelines to perform a same task. The control of execution is also simplified in handling hazards such as those associated with data, structural and pipeline, in a traditional pipeline.

In standard processors, execution involves traversing pipelines (such as from register to ALU to register) for multiple times. The underlying concept of pipelines is nothing but breaking down a task into stages, where a first piece of data to be operated on passes through one stage and moves to the next stage while the second piece of data is moved into first stage. Accordingly, operations can be continuously performed at each stage. The completion of an instruction or a task occurs when the associated operands or data have passed through all the stages.

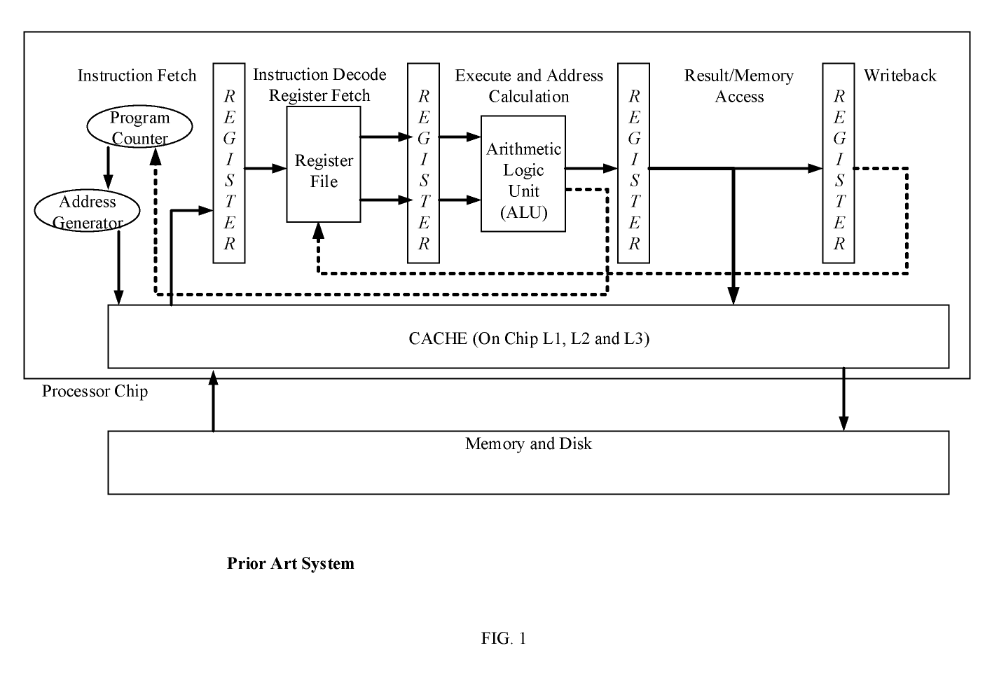

At a top level, in a traditional processor pipeline, as shown in FIG. 1, since there is only one entity that executes the instruction (including multiple stages), an operand has to go from one register to an ALU execution unit and go back to the same or different register. Registers are usually limited in number. Such limitation leads to conflicts, also known as structural hazards for resourcing and scheduling. It also leads to data hazards, such as RAW (Read after Write), WAR (Write after Read) and WAW (Write after Write), and control hazards that are introduced when branches or jumps are required in the underlying computer programming code.

In accordance with the present teachings, a graph processor allows for resolution to the aforementioned hazards with the use of multiple resources and the flexibility of implementing the top level data flow by introducing variable delays. The variable delays provide flexible scheduling, pre-emptive execution and results of such execution. The results are made available to the main flow without disrupting the flow by performing pre-emptive execution in another part of the graph processor. In the graph processor, the interconnecting port blocks are an extension of processor cache, memory, switching/routing and registers for results and/or operands at every stage of a pipeline. Accordingly, RAW, WAR and WAW hazards are avoided with additional resources, such as registers. Register forwarding is also simplified as execution of a flow graph is based on the execution path through the graph processor. Moreover, the structure of the BSE and RSE elements allows for the next atomic units (one or more) in the instruction chain to have access to the data stored in the port block (BSE/RSE).

Another advantage of the resource interconnection topology of the graph processors in accordance with the present teachings is the capability to map multiple types of data or control graph topologies to a graph processor. The processor with a simple memory based switches can implement any type of Generalized Connection Network (“GCN”) between the resource elements. Accordingly, a graph processor is capable of supporting SIMD (Single Instruction Multiple Data), MIMD (Multiple Instruction Multiple Data), SISD (Single Instruction Single Data) and MISD (Multiple Instruction Single Data) machines with multiple concurrent control and data streams running through the processor. Generally, processors are classified using Flynn's Taxonomy as SISD, SIMD, MISD and MIMD. In accordance with the present teachings, the graph processor also supports multiple instances of a mix of the four types of machines running at the same time using resources of switched memories and atomic execution units in the planar or non-planar matrix.

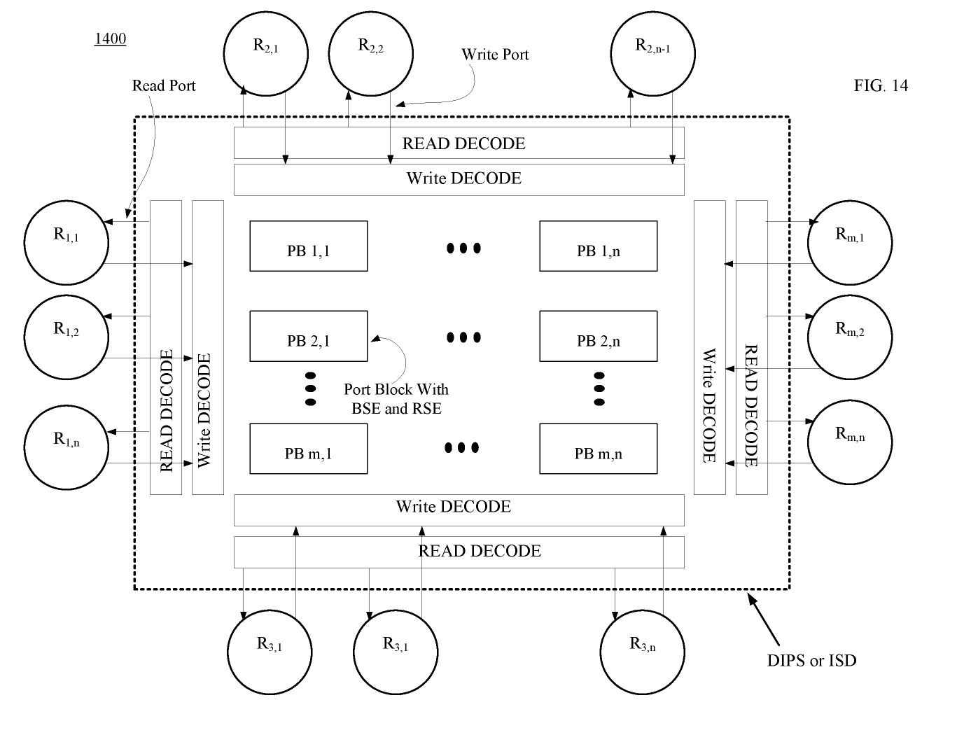

For graph processors, such as the processors 502,600,800,1400, the scheduler 1110 generates scheduled operations residing in a scheduling operations block 1108. The processor 1400 of FIG. 14 is an Integrated Switching Device (“ISD”) based graph processor. The processor 1400 is connected to the output and input ports of the ISD which is set forth as a Dynamic Integrated Programmable Switch (“DIPS”) device in the U.S. Pat. No. 6,504,786. The ISD is controlled by a central scheduler. The central scheduler routes control flow graph or data flow graph based instructions to various execution units of the device. This device functions as a switch to which other peripherals can be connected to form a complete system on a chip. Based on the granularity of the execution units (such as atomic execution units, simplified RISC engines or others), the central scheduler determines the level at which scheduling takes place. The scheduler can be implemented either in software or hardware in an embedded processor or in dedicated custom hardware.

The scheduling changes depending on the type of units connected to the ports of the ISD. In other words, the level (such as processes, threads, instructions, etc.) at which the scheduling is performed affects the scheduling. For example, where there is a function call for a specific encoding operation, the encoding operation can be scheduled to be performed by an encoding hard macro or a dedicated encoding unit connected to one of the ports of the ISD. A hard macro is an Application Specific Integrated Circuit (“ASIC”) portion. Generally, an ASIC has one or more intellectual property (“IP”) cores or blocks. The IP blocks are instantiated as hard macros. In contrast, soft macros are reprogrammable as in an FPGA. As an additional example, when an operation requires writing to an I/O port, the operation can be routed to the I/O port where an I/O controller block/macro is connected to the ISD. Accordingly, the graph processor 1400 can be used to build systems on a chip where the ISD can replace system cache and also serve as a switched interconnect for the SOC. One of the ports of the ISD can be connected to a large cache such as the one that is fully set forth in U.S. Pat. No. 6,584,546.

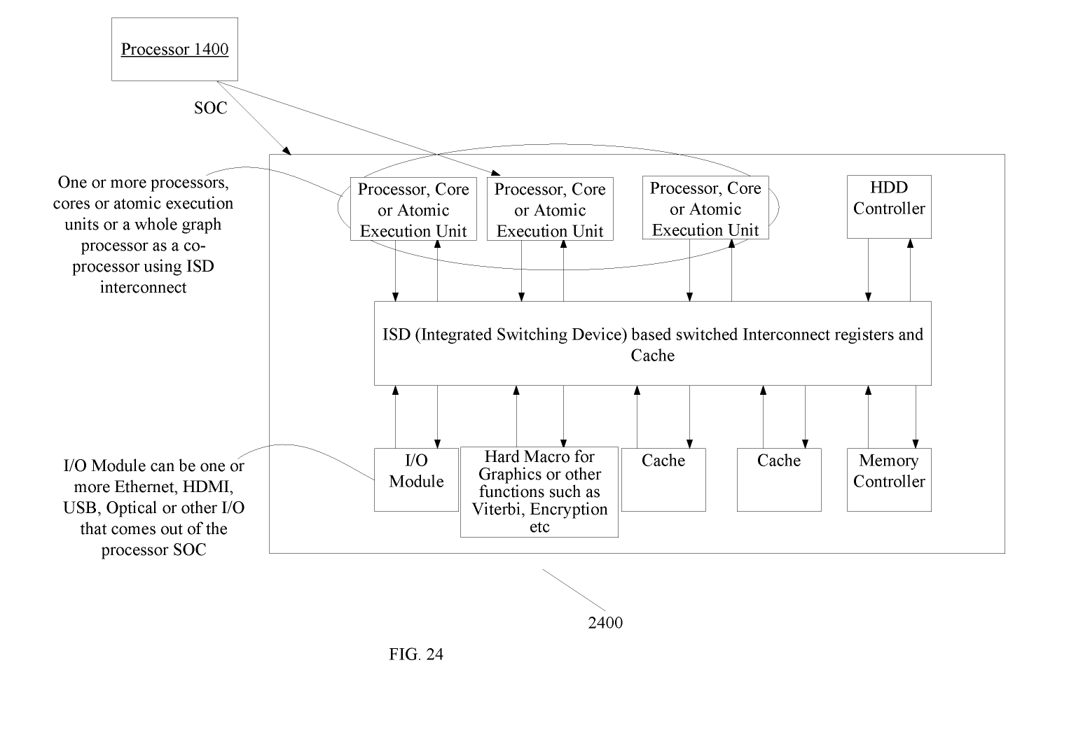

An illustrative implementation of such a SOC is shown and indicated at 2400 in FIG. 24. Elements of the SOC 2400 can be inside a single chip in the form of an SOC, a system on a motherboard or a printed circuit board (“PCB”) with each of the elements implemented in a separate semiconductor device. Based on various drivers, a designer might choose to incorporate various elements of the SOC 2400 in one chip, separate chips or in a system on a board.

The scheduled operations are time based controls for the switched memories, such as the switched memory 602, that are implemented using RSEs and BSEs. As shown in FIG. 21, the scheduled operations are stored in a linear array 2102 which allows for linear indexing of the port blocks of a planar matrix array. In other words, the scheduled operations are stored in a memory that is indexed linearly. Each indexed memory location or register can be 32 bits, 64 bits or any other number of bits and represents a single row of atomic execution units or one atomic execution unit at different time slices. For example, where each indexed memory location or register represents a single row in a bank and is 36 bits, each three bits represent one element (such as a RSE or BSE). In such a case, each indexed memory location or register can represent six port blocks. The bits of each register can be directly wired with the corresponding port blocks for the graph processor 502,600,800,1400.

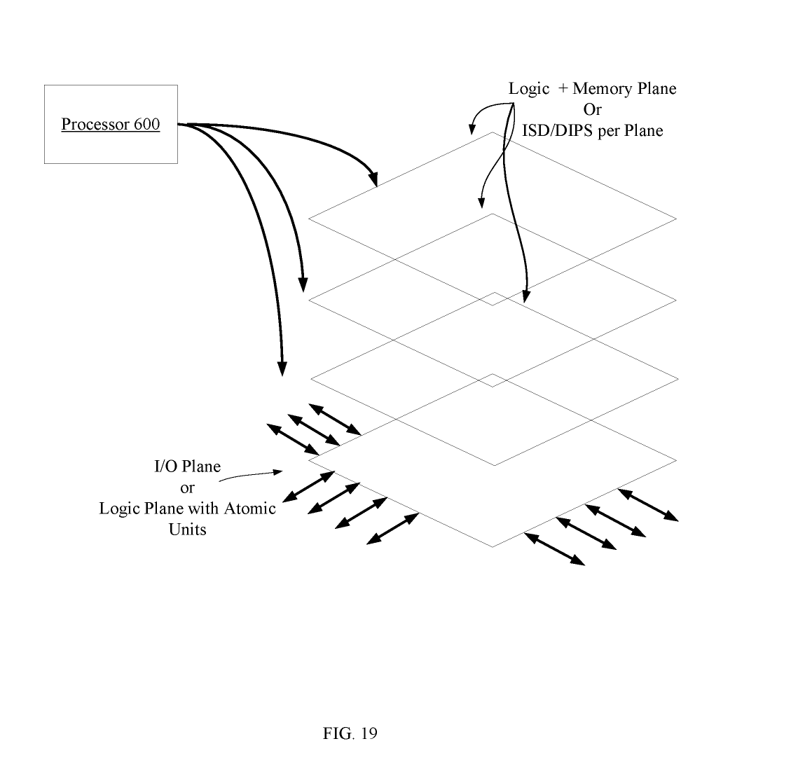

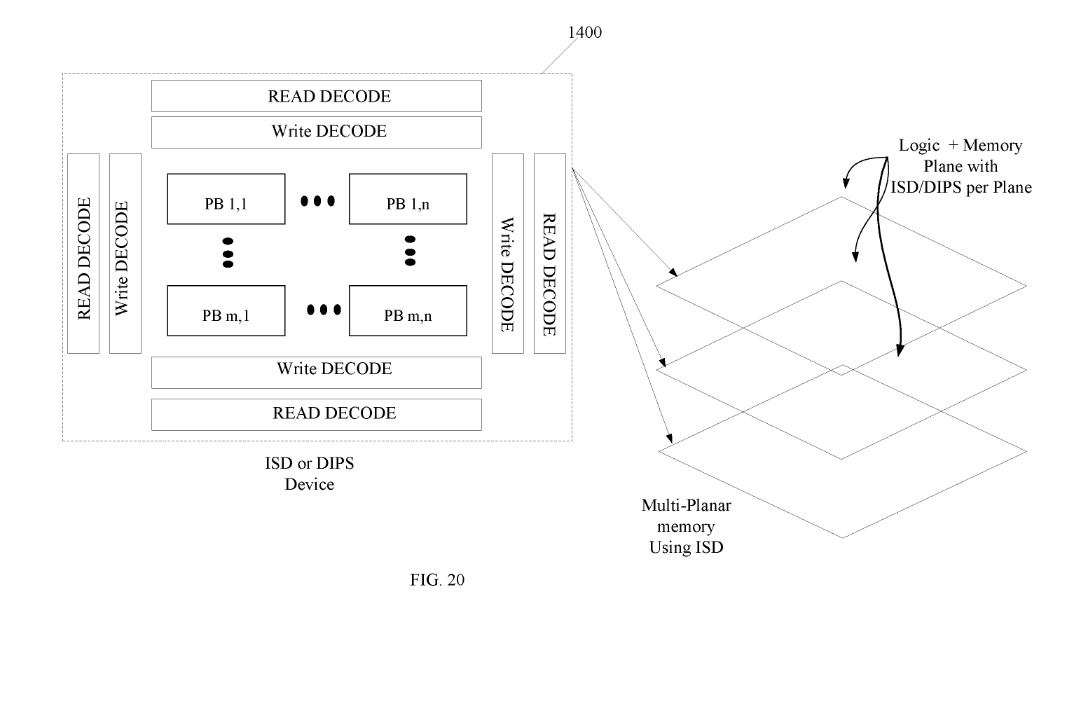

FIGS. 19 and 20 demonstrate ISD based implementations of non-planar or 3-D graph processors 600 and 1400, where the ISD is stacked in a 3-D structure. The interconnecting wires can be optical channels embedded in silicon or structures present in current semiconductor devices. Conventional means for forming such interconnects is a multi-chip module. Moreover, the I/O of each bank that come to the edges of the die are connected to the I/O of another die; and multiple such dies are put on a single substrate into the multi-chip module. Newer manufacturing techniques allow for stacked dies where the dies are put on top of each other and I/Os are interconnected (also known as 3-D packaging). Within a 3-D packaging, each die can have a dedicated function or a mixed function, such as a graph processor, with interconnected BSEs and RSEs on each die.

Alternatively, certain dies of a 3-D packaging contain only logic functions, such as atomic operation units, and a different die contains the ISD. Furthermore, all the dies are interconnected through the I/Os. A different method of packaging is the stacked silicon interconnects (“SSI”), such as the SSI technology being pioneered by Xilinx Inc. As a further example, a graph processor can be built using 3-D semiconductor processes, by which microelectronics manufacturers construct 3-D chip stacking utilizing Through Silicon Via (“TSV”) chip to chip interconnects. These types of interconnects provide high density silicon devices where the logic, memory and other functions can be combined on the same device by direct stacking of silicon dies. The Multiple Chip Packages Committee at JEDEC (JC-63) is currently developing mixed technology pad sequence and device package standards to enable SRAM, DRAM and Flash memory to be combined into a single package that may also contain processor(s) and other devices.

Obviously, many additional modifications and variations of the present disclosure are possible in light of the above teachings. Thus, it is to be understood that, within the scope of the appended claims, the disclosure may be practiced otherwise than is specifically described above. For example, the planar matrix array can be arranged in a topology that is different from a cuboid structure. As an additional example, the planar matrix array can be arranged in a topology that is different from a cuboid structure, such as a toroid, a hypercube, a ring or other form of networks.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below.

1-24. (canceled)

25. A graph processor comprising:
i) a planar matrix array wherein the planar matrix array includes a set of planar matrices wherein each planar matrix includes a set of resources, wherein the set of resources are interconnected through port blocks and each resource of the set of resources is an atomic execution unit, wherein the atomic execution unit executes a single type of instruction; and
ii) a switched memory wherein the switched memory includes port blocks for interconnecting the set of planar matrices.

26. The graph processor of claim 25 wherein the set of planar matrices includes more than one planar matrix.

27. The graph processor of claim 25 wherein two sets of resources of two different planar matrices of the planar matrix array are interconnected through port blocks at their intersections as well as on the edges.

28. The graph processor of claim 25 wherein two sets of resources of two different planar matrices of the planar matrix array are interconnected through the switched memory in a particular row and column

29. The graph processor of claim 25 wherein each of the port blocks includes a broadcast switch element and a receive switch element.

30. The graph processor of claim 25 wherein a plurality of atomic execution units of the planar matrix array form an execution path wherein the execution path maps an input to an output.

31. The graph processor of claim 30 wherein the execution path corresponds to a self-routing instruction.

32. The graph processor of claim 25 further comprising a linearized matrix array for scheduling and for tracking state wherein each entry in the linearized matrix array indicates a type, a state and coordinates of a corresponding resource of the planar matrix array.

33. The graph processor of claim 25 wherein the graph processor is a multi-chip package with a set of dies wherein each die in the set of dies contains a different part of the graph processor.

34. The graph processor of claim 33 wherein a first die in the set of dies contains an Integrated Switching Device (ISD) and a second die in the set of dies contains an Application Specific Integrated Circuit (ASIC) macro wherein the ASIC macro is connected to the ISD.

35. The graph processor of claim 33 further comprising a run time scheduler wherein the run time scheduler dynamically creates an execution path wherein the execution path traverses a plurality of atomic execution units within the graph processor.

36. The graph processor of claim 25 wherein the graph processor is a Three Dimensional (3-D) semiconductor stacking structure wherein the stacking structure includes different dies that are stacked together, wherein the dies are connected via a Through Silicon Via (TSV).

37. The graph processor of claim 36 wherein the TSV connects port blocks of the planar matrix array with the switched memory.

38. The graph processor of claim 25 wherein the graph processor supports execution of simultaneous pipelines of varying depth.

39. The graph processor of claim 38 wherein the graph processor operates as a Single Instruction Multiple Data (SIMD), a Multiple Instruction Multiple Data (MIMD), a Single Instruction Single Data (SISD) or a Multiple Instruction Single Data (MISD) machine based on input data being processed by the graph processor.

40. The graph processor of claim 38 wherein the graph processor simultaneously executes multiple instances of at least one of a SIMD, MIMD, MISD or SISD machine.

41. The graph processor of claim 25 wherein the switched memory is a cache for the graph processor.

42. The graph processor of claim 41 wherein the graph processor is a co-processor.

43. The graph processor of claim 41 wherein the set of planar matrices and the switched memory operate on the same clock or on different clocks.

44. The graph processor of claim 41 wherein the switched memory is implemented using Dynamic Random-access Memory (DRAM), Static Random-access Memory (SRAM) or Magnetic Random-access (“MRAM”) cells.

45. A method for executing a set of computer program instructions on a graph processor, the method comprising:
i) linearizing the state, type and coordinates of each resource in a planar matrix array of a graph processor into a linearized matrix array, wherein the planar matrix array includes a set of planar matrices wherein each planar matrix includes a set of resources, wherein each resource is an atomic execution unit, wherein the atomic execution unit executes a single type of instructions;
ii) determining a flow graph corresponding to a set of computer program instructions;
iii) linearizing a portion of the flow graph into a score board wherein the score board includes at least one node of the portion of the flow graph;
iv) based on the linearized matrix array, mapping one node of the portion of the flow graph to an available resource of the planar matrix array; and
v) the available resource executing the operation defined by the mapped node on the graph processor.

46. The method of claim 45 wherein the set of planar matrices includes more than one planar matrix.

47. The method of claim 45 wherein the flow graph is a data flow graph.

48. The method of claim 45 wherein the flow graph is a control flow graph.
